(19) United States
(12) Patent Application Publication
(10) Pub. No.: US 2012/0024986 A1
(43) Pub. Date: Feb. 2, 2012

(54) Hand-Held Type Harmful Insect Exterminator

(75) Inventors: Takeshi Shouji, Shizuoka (JP); Akira Kasahara, Fukuoka (JP); Michimasa Kawaragi, Shizuoka (JP)

(73) Assignee: HINOX SHOJI CO., LTD., Tokyo (JP)

(21) Appl. No.: 13/116,543

(22) Filed: May 26, 2011

(30) Foreign Application Priority Data
Jul. 27, 2010 (JP) 2010-167868

(51) Int. Cl. B05B 9/01

(52) U.S. Cl. 239/526

(57) ABSTRACT

The present invention relates to a hand-held type harmful insect exterminator. The present invention comprises a tube having its extremity end formed at a suction port and its rear end formed at an outlet and a handle for supporting the tube, and tube having a suction machine. A storing part for insects sucked at the suction port is removably arranged at the extremity end of a feeding passage communicated with the tube. The present invention is comprises a filter-like lid. This lid is used for closing an inlet of the feeding passage communicated with the tube and when the switch is turned on, open the inlet of the feeding passage and for closing an air flow passage within the tube to prevent the insects to flowing to the outlet.

### BACKGROUND OF INVENTION

1. Field of Invention

The present invention relates to a hand-held type harmful insect exterminator of which size and weight are formed at one that a user can hold it with one hand.

2. Description of Related Art

As the conventional harmful insect exterminator, there is a product described in the gazette of U.S. Pat. No. 4,449,319, for example.

The conventional product is constituted in such a way that a suction machine is arranged within a cylindrical housing, wherein the other end of the housing that is an outlet for air is provided with impaling means for impaling insects under air pressure.

Accordingly, the conventional product had some problems that some insects not impaled but still lived are accumulated at the other end of the housing and run away into the housing.

In addition, the conventional product requires to remove the other end of the housing when the sucked and impaled insects are put into the discard. Due to this fact, when the insects are put into the discard through this conventional product, it showed a problem that the insects could easily run away.

Additionally, the conventional product could easily generate a certain trouble against a sucking action due to accumulation of eggs of insects at the other end of the housing when they were sucked, for example.

Thus, as one example of the conventional product that the caught insects are stored in a container, there is a product described in the gazette of U.S. Pat. No. 5,367,821, for example.

The conventional product is operated such that a piston is stored in a cylinder and when a trigger is pulled to cause the piston to move rearward with a recovering force of a spring. Then, the conventional product has a structure in which the insects are sucked under a negative pressure generated at that time.

However, the conventional product has an inlet of a container that is always opened.

Accordingly, the conventional product sometimes caused the insects to run away from within the container and could not store the insects positively within the container.

In addition, the conventional showed a troublesome sucking operation due to the fact that the piston was required to be pushed with a hand every time the insects were sucked so as to set it.

### SUMMARY OF INVENTION

The present invention has been suggested in view of the Problems found in such a conventional product described above.

Accordingly, a technical theme to be resolved by the present invention consists in providing a hand-held harmful insect exterminator constituted in such a way that the caught insects can be prevented from being run away from the storing location, the sucking operation can be carried out simply and easily and not only the insects but also the eggs of insects deposited on a leaf and the like can be positively stored and caught.

In order to resolve the aforesaid theme, the present invention provides the technical means as follows.

That is, as shown in FIG. 1 and the like, the present invention is comprises a tube having its extremity end formed at a suction port and its rear end formed at an outlet and a handle for supporting the tube, wherein the tube has a suction machine for sucking surrounding air through the suction port when a user holds it with the handle to turn on a switch, storing part for insects sucked at the suction port with this suction machine is removably arranged at the extremity end of a feeding passage communicated with the tube, and there is a filter-like lid for closing an inlet of a feeding passage communicated with the tube and when the switch is turned on, open the inlet of the feeding passage and for closing an air flow passage within the tube to prevent the insects to flowing to the outlet (Claim 1).

In the present invention, it is preferable that a net in the lid can be appropriately selected in response to the kind of insects and the like. Under a normal state, the lid is arranged in a state for closing the inlet of the feeding passage. Then, the lid is sprung up or wound up, for example, when the switch is turned on, thereby the lid is arranged at a state for opening the inlet of the feeding passage and for closing the air flow passage within the tube.

In this case, it is preferable that the lid is arranged to close the air flow passage within the tube under its forward inclined posture facing toward the suction part when the switch is turned on (Claim 2).

Because this posture state in which the lid is kept to be inclined facilitates to guide the insects struck against the lid and dropped down toward the inlet of the feeding passage.

Thus, it is preferable in the present invention that there is an air accepting plate for assisting a lid raising action upon accepting air pressure of air flow into the tube (Claim 3).

Because this system can provide an easy and more efficient changing-over control of an air flow passage under utilization of sucked air.

Additionally, in this case, it is preferable that the present invention is formed by comprising an electromagnet arranged near the inlet of the feeding passage for generating magnetic power when the switch is turned on, a first permanent magnet arranged at the upper side position of the lid corresponding to the electromagnet to repel against the electromagnet at the time of its energizing action, a stopper arranged in a protruded step state at the inner surface of the tube so as to stop motion of the raised lid, and a second permanent magnet arranged at the stopper to repel against the first permanent magnet (Claim 4).

Because it is possible to spring up the lid to open the feeding passage immediately when the switch is turned on under utilization of the repelling force acted between the electromagnet and the first permanent magnet. In addition, with this arrangement as above, it is possible to perform an instant descending of the lid under utilization of the repelling force acted between the first permanent magnet and the second permanent magnet when the operated of the sucking machine stops and to close the inlet of the feeding passage.

Additionally, in this case, when the inlet of the feeding passage is closed with the lid, the first permanent magnet is attracted against the iron core of the electromagnet kept in non-energized state. Accordingly, with this arrangement, the present invention provides an effect that even if the product is inclined or turned upside down, the inlet of the feeding passage can be tightly closed with the lid and it is possible to prevent positively the caught insects from running away off the storing part.

In addition, it is preferable for the present invention to have an arrangement in which the handle is formed into a tubular shape, the inner side of the handle is formed into a feeding passage and the lower end of the handle is provided with the storing part that is communicated with the feeding passage (Claim 5).

Because, with this arrangement as above, it is possible to make a small-sized and light weight unit as compared with the case in which the feeding passage is formed separate from the handle. Further, in accordance with this arrangement, it is possible to make a simple outer appearance and to provide the product of the present invention having a superior design formation.

Due to this fact, a size and a shape of each of the harmful insects and eggs of insects are different in view of their kind (for example, tick, aphid, green caterpillar, stinkbug or the like). In addition, the insects adhere at different locations such as leaves and stalks. Accordingly, it is preferable for the present invention to make an arrangement in which the suction port is formed by an independent component having brush-like bristle and the component is formed in such a way that it can be replaced at the extremity end of the tube in such a way that the insects and eggs of insects can be scraped away and positively sucked (Claim 6).

In the case of the present invention, replacement of the suction port is realized by fitting or screwing the suction port to the extremity end of the tube, for example.

Since the present invention is formed like this, it is possible to prevent the caught insects from being run away from the storing part by the filter-like lid.

In addition, the present invention enables a user to carry it, use it with only one hand and perform a simple and easy sucking operation.

Additionally, in accordance with the present invention, not only insects such as caterpillars or green caterpillars but also eggs of insects deposited on the leaves can be positively stored and caught.

### BRIEF DESCRIPTION OF DRAWINGS

FIG. 1 is a side view showing a preferable embodiment of a harmful insect exterminator in the present invention.

FIG. 2 is an essential cross sectional view showing the harmful insect exterminator in the present invention.

FIG. 3 is an essential structural view showing the harmful insect exterminator in the present invention.

FIG. 4 is a time chart when a switch is pushed.

FIG. 5 is an essential exploded side view showing the harmful insect exterminator in the present invention.

FIG. 6 is a side view for explaining a storing part.

FIG. 7 is a perspective view showing a state of use for the harmful insect exterminator in the present invention.

FIG. 8 is an essential perspective view showing a suction port.

FIG. 9 is an essential cross sectional view showing the suction port.

### DESCRIPTION OF PREFERRED EMBODIMENTS

The following preferable embodiment for carrying out present invention will be described according to the attached drawings.

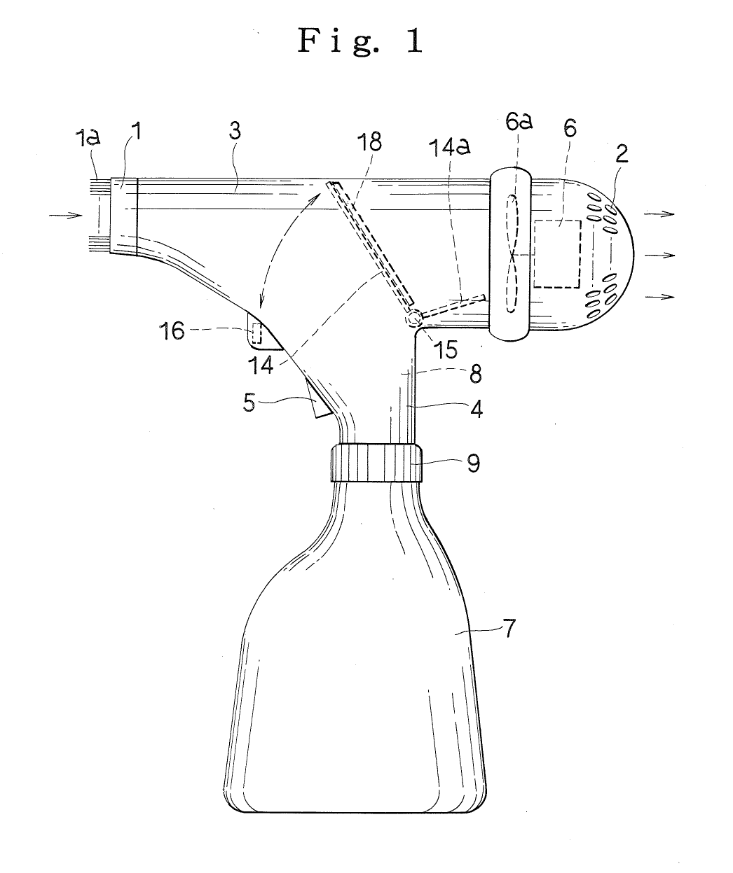

As shown in FIG. 1 and the like, the present invention is formed by a tube 3 having its extremity end formed at a suction port 1 and its rear end formed at an outlet 2, and a handle 4 for use in supporting the tube 3.

Then, the present invention is constituted in such a way that the tube 3 is provided with a suction machine 6 for sucking surrounding air through the suction port 1 when a switch 5 is turned on while a user holds the handle 4. In addition, the present invention is constituted such that a storing part 7 for storing insects sucked at the suction port 1 by the suction machine 6 is arranged at the extremity end of a feeding passage 8 communicated within the tube 3 in such a way that the storing part can be removed.

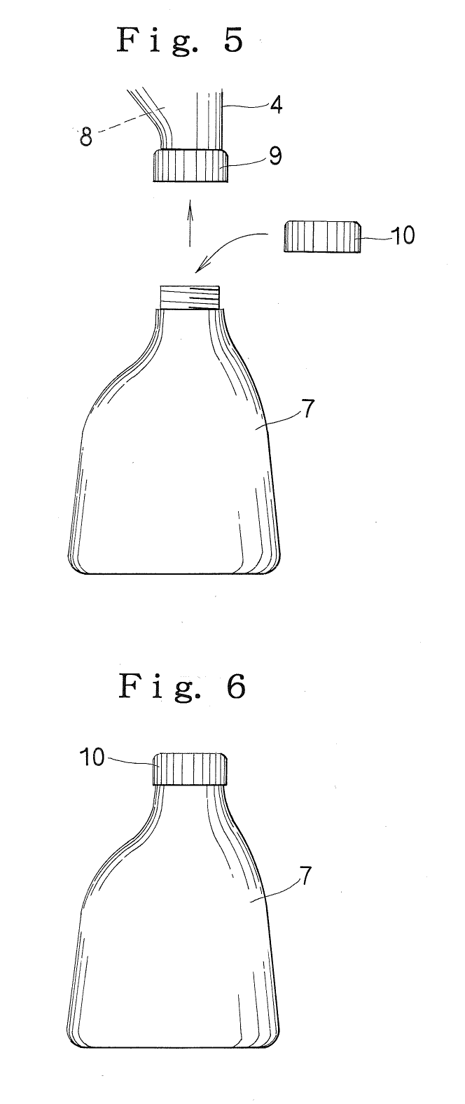

The aforesaid handle 4 in this preferred embodiment is formed into a tubular shape. Then, the inner side of the handle 4 is formed to act as the feeding passage 8. In addition, the storing part 7 is fixed to the lower end of the handle 4 by a threaded engagement type joint member 9 in such a manner that the storing part 7 is communicated with the feeding passage 8. As shown in FIGS. 5 and 6, the storing part 7 in this preferred embodiment is formed like a bottle shape. Then, in the case that the storing part 7 is removed from the lower end of the handle 4, the port of the storing part 7 can be closed by threaded engagement of a cap 10.

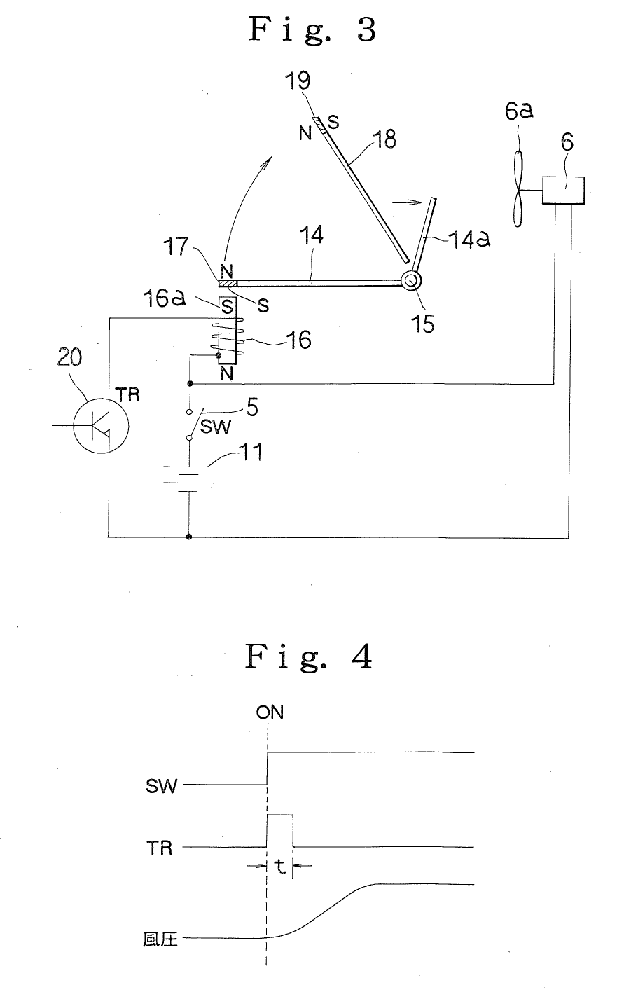

In addition, the suction machine 6 is formed at a motor provided with a propeller 6a. As shown in FIG. 3, the suction machine 6 is stored at the rear end of the tube 3 and formed in such a way that the suction machine 6 is operated in the case that the switch 5 is turned on.

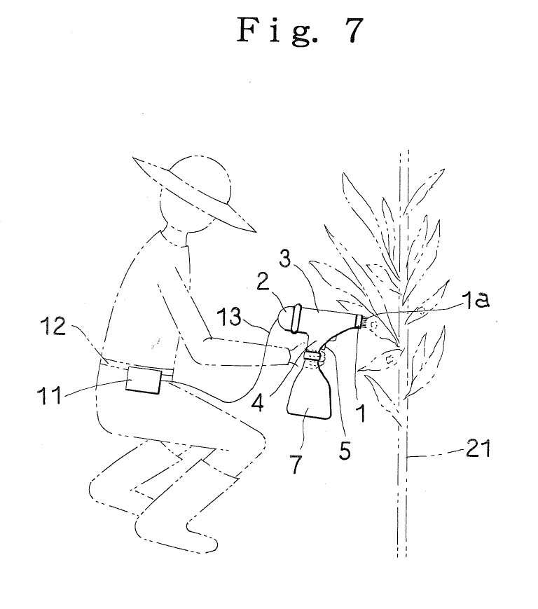

Further, as shown in FIG. 7, a battery 11 in this preferred embodiment is formed in such a way that it can be installed at a belt 12 and the battery is electrically connected to the suction machine 6 and the like through an electric cord 13.

In addition, the present invention is formed to be provided with a filter-like lid 14 that closes the inlet of the feeding passage 8 opened into the tube 3, opens the inlet of the feeding passage 8 when the switch 5 is turned on, and closes the air flow passage within the tube 3 to prevent the insects from flowing toward the outlet 2. This lid 14 is arranged at a state in which the air flow passage within the tube 3 is closed under its forward inclined posture facing toward the suction port 1 when the switch 5 is turned on.

In addition, the present invention is formed to be provided with an air accepting plate 14a for assisting the lid 14 raising action upon accepting air pressure of air flow into the tube 3. In this preferred embodiment, the air accepting plate 14a is fixed to a shaft 15 together with the lid 14. In this case, a fixing angle between the air accepting plate 14a and the lid 14 is selected as about 115° C. around the shaft 15 in such a way that the lid 14 can be raise-up efficiently by air pressure. This angle is preferably selected in reference to the shape of the air accepting plate 14a and the like.

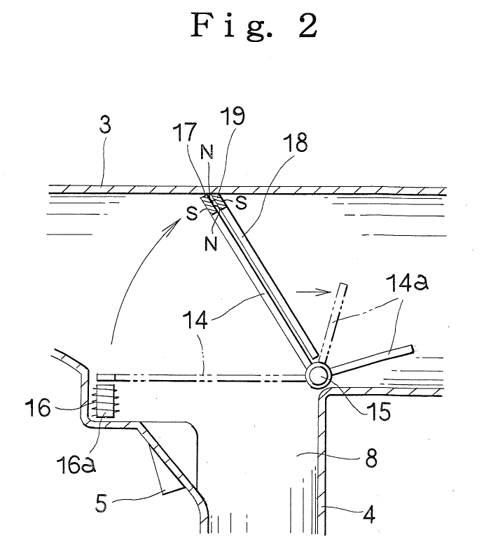

As shown in FIG. 2 and FIG. 3, the present invention in its preferred embodiment is formed by comprising an electromagnet 16 arranged near the inlet of the feeding passage 8 for generating magnetic power when the switch 5 is turned on, a first permanent magnet 17 arranged at the upper side position of the lid 14 corresponding to the electromagnet 16 to repel against the electromagnet 16 at the time of its energizing action, a stopper 18 arranged in a protruded step state at the inner surface of the tube 3 so as to stop motion of the raised lid 14, and a second permanent magnet 19 arranged at the stopper 18 to repel against the first permanent magnet 17. This stopper 18 in this preferred embodiment is formed like U-shape as viewed from the extremity end of the tube 3.

The lid 14 is attracted against the iron core 16a of the electromagnet 16 under an action of the first permanent magnet 17 because the aforesaid electromagnet 16 does not generate any magnetic force when the switch 5 turned off. Then, when the switch 5 is turned on, the sucking machine 6 is operated to suck surrounding air and electric current instantly flows at the electromagnet 16 under an action of the switching element 20 (refer to FIG. 4).

In this case, the magnetic pole of the electromagnet 16 and the magnetic pole of the first permanent magnet 17 are selected in the same polarity. Accordingly, the lid 14 turns around the shaft 15 under an action of its repelling force and air pressure accepted by the air accepting plate 14a and sprung up. Then, the lid 14 is stopped against the stopper 18 and being pushed against the stopper 18 with air pressure during the time in which the sucking machine 6 is operated to suck the surrounding air.

Further, in this case, it is also preferable in the present invention that the shaft 15 is externally provided with a bearing so as to make a smooth turn of the lid 14. In addition, it is also preferable to form the present invention in such a way that the electric current flowed in the electromagnet 16 is increased or a shape of the iron core 16a is changed to cause the magnetic force to be increased, its repelling force is increased to make a fast spring up speed.

Then, as the lid 14 is sprung up, the inlet of the feeding passage 8 is opened and the air flow passage within the tube 3 is closed by the lid 14. However, since the lid 14 is formed like a filter, the sucked surrounding air flows rearward through the net of the lid 14 and is discharged out of the outlet 2. In turn, the sucked harmful insects and eggs of insects are guided to the feeding passage 8 while the sprung up lid 14 acts as a guiding plate and then they are stored at the storing part 7.

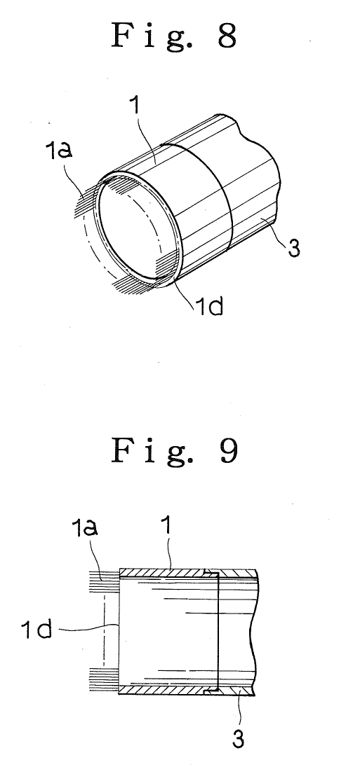

In addition, as shown in FIG. 8 and FIG. 9, the suction port 1 in the present invention is provided with brush-like bristles 1a and the suction port 1 is arranged at the extremity end of the tube 3 in such a way that it can be freely replaced. The suction port 1 is formed at the extremity end of the tube 3 like a fitting type and formed at an independent component. The bristles 1a are planted at the extremity end 1d in an annular shape with their tips being faced forward under their overlapped state so as to be suitable for sucking the harmful insects and eggs of insects disposed at the leaves.

Then, an example of use and action of the present invention will be described as follows.

As shown in FIG. 7, for example, a user holds the handle 4, directs its suction port 1 against the insect and turns on the switch 5. Then, the sucking machine 6 operates to suck the surrounding air. In addition, an electric current flows in the electromagnet 16 (refer to FIG. 2 and FIG. 3) to generate a magnetic field.

In this case, the magnetic poles of the electromagnet 16 and the first permanent magnet 17 are the same polarity. Accordingly, the lid 14 instantly turns around the shaft 15 under an action of repelling force between the magnets and air pressure accepted by the air accepting plate 14a and is sprung up, strikes against the stopper 18 and stops there.

In this case, air pressure is higher than the repelling force generated between the second permanent magnet 19 of the stopper 18 and the first permanent magnet 17 of the lid 14. Due to this fact, the lid 14 is kept under its sprung up posture.

In this way, when the lid 14 is sprung up, the inlet of the feeding passage 8 is opened. Then, the insects sucked into the tube 3 strike against the lid 14 and are guided into the feeding passage 8, and enter into the storing part 7 through the feeding passage 8. In addition, since the lid 14 is formed like a filter, the air flows toward the outlet 2 and is discharged out of the outlet 2.

Then, the user loses finger from the switch 5. With this action, operation of the sucking machine 6 stops and the surrounding air sucking operation stops. Then, the lid 14 is released from the stopper 18 under the repelling force between the first permanent magnet 17 and the second permanent magnet 19. Then, the lid 14 turns downward around the shaft 15 and descends and is attracted against the iron core 16a of the electromagnet 16 and stopped. At this time, small insects or eggs of insects adhered to the mesh of the lid 14 are shaken and dropped down through vibration and shock generated when they strike against the iron core 16a, drop through the inlet of the feeding passage 8 onto the storing part 7 and they are stored there.

The lid 14 is attracted against the iron core 16a of the electromagnet 16 at the time of non-energizing with a magnetic force of the first permanent magnet 17. Accordingly, since the inlet of the feeding passage 8 is tightly closed with the lid 14, even if the product of the present invention is inclined or turned upside down, the inlet of the feeding passage 8 is not opened. With this arrangement as above, the present invention can prevent the insects form running away from the storing part 7.

Further, as shown in FIG. 5, when the insects are to be disposed, the joint member 9 is loosened and the storing part 7 is removed from the lower end of the handle 4 so as to perform the disposing action. In this case, when a cap 10 is fastened at the port of the bottle-type storing part 7 and applied to the sunlight, a temperature within the storing part is increased and the insects die. In addition, since the inside of the storing part 7 shows a lack of oxygen, the insects die even if the temperature of the inside of the storing part 7 is not increased.

With the arrangement as above, the aforesaid example shows that the sucking machine 6 is being kept for operating and sucking state continues while the switch 5 is being pushed.

However, the present invention is not restricted to the arrangement described above. That is, it is also preferable for the present invention to provide an arrangement in which a self-holding action is applied by a relay, for example, to keep the operated state of the sucking machine 6 even if the finger is released from the switch 5 when the switch 5 is once turned on, and when the switch 5 is turned on again, the operation terminates.

What is claimed is:

1. A hand-held type harmful insect exterminator comprises a tube having its extremity end formed at a suction port and its rear end formed at an outlet and a handle for supporting the tube, wherein the tube has a suction machine for sucking surrounding air through the suction port when a user holds it with the handle to turn on a switch, a storing part for insects sucked at the suction port with this suction machine is removably arranged at the extremity end of a feeding passage communicated with the tube, and there is a filter-like lid for closing an inlet of the feeding passage communicated with the tube and when the switch is turned, open the inlet of the feeding passage on and for closing an air flow passage within the tube to prevent the insects to flowing to the outlet.

2. The hand-held type harmful insect exterminator according to claim 1, wherein the lid is arranged to close the air flow passage within the tube under its forward inclined posture facing toward the suction port when the switch is turned on.

3. The hand-held type harmful insect exterminator according to claim 2, wherein there is an air accepting plate for assisting a lid raising action upon accepting air pressure of air flow into the tube.

4. The hand-held type harmful insect exterminator according to claim 3, wherein the same is formed by comprising an electromagnet arranged near the inlet of the feeding passage for generating magnetic power when the switch is turned on, a first permanent magnet arranged at the upper side position of the lid corresponding to the electromagnet to repel against the electromagnet at the time of its energizing action, a stopper arranged in a protruded step state at the inner surface of the tube so as to stop motion of the raised lid, and a second permanent magnet arranged at the stopper to repel against the first permanent magnet.

5. The hand-held type harmful insect exterminator according to claim 4, wherein the handle is formed into a tubular shape, the inner side of the handle is formed into a feeding passage and the lower end of the handle is provided with the storing part that is communicated with the feeding passage.

6. The hand-held type harmful insect exterminator according to claim 5, wherein the suction port is formed by an independent component having brush-like bristles and the component is formed in such a way that it can be replaced at the extremity end of the tube.
